(19) United States
(12) Patent Application Publication
(10) Pub. No.: US 2007/0236023 A1
(43) Pub. Date: Oct. 11, 2007

(54) Concrete anchor bolt holders and methods of use

(76) Inventor: Josh Beery, Fresno, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 11/805,918

(22) Filed: May 25, 2007

Related U.S. Application Data
(63) Continuation-in-part of application No. 11/378,517, filed on Mar. 17, 2006.

(51) Int. Cl. F16B 43/00

(52) U.S. Cl. 292/341.14

(57) ABSTRACT

The present invention is a two-piece anchor bolt holder with an internal clip that may be easily engaged with and disengaged from an anchor bolt used in building construction, and methods of use. Embodiments of the invention include colored bolt-engaging clips that are temporarily but securely attached to anchor bolts. The clips may be of different sizes for different sized bolts. Separate brightly-colored housings are provided that fit over and temporarily but securely attach to the clips. Embodiments of the housings are provided with a pivotally or hinged attached extension piece or bracket. Embodiments of these brackets may be temporarily but securely engaged with framing walls or other nearby structures to provide stability to the housing, clip and anchor bolt while concrete is poured around the bolt.

This application claims the benefit of and is a continuation-in-part of U.S. Utility patent application Ser. No. 11/378,517 filed on Mar. 17, 2006, which is incorporated herein in its entirety by this reference.

### BACKGROUND OF THE INVENTION

1. Field of the Invention

The present invention relates to concrete anchor bolt holders and positioners, and more particularly to new and improved devices for holding anchor bolts and related structures while concrete is being poured around them, the two-part devices being easily affixed to and disengaged from the anchor bolts and adjacent structural components, the devices being brightly colored to increase their visibility and improve safety at a worksite.

2. Description of the Prior Art

In the field of construction, building structures are commonly placed on a concrete foundation. To increase structural stability, the frame of the structure is fixedly connected to the concrete foundation by anchor bolts or other metal structural members (such as rebar). For simplicity herein, the term anchor bolt is used to refer to any such metal structural member including without limitation smooth or threaded anchor bolts, rebar, and the like. The use of such anchor bolts ensures that the building structure will not shift with respect to the foundation. The use of anchor bolts are very common and are oftentimes required in areas subject to natural disasters that might increase the chance of a building being shifted from its foundation such as in regions susceptible to earthquakes, flooding, mudslides, tornadoes, hurricanes, high winds, or with respect to building structures built on steep grades.

Anchor bolts are usually positioned when framing the foundation site before pouring concrete. Anchor bolts can vary in size, shape and length. Some anchor bolts are arcuate in nature, or hooked to fit around reinforcement metal supports laid within the concrete foundation. Most standard anchor bolts sit vertically in the concrete, and many are threaded as to allow for the secure attachment to the frame of a building structure.

The standard process for setting anchor bolts involves creating a wooden retainer frame for the foundation and placing anchor bolts in the correct location. In most cases, pairs of wooden frames are set between six and twelve inches apart to form a concrete “curb” from which the anchor bolts will protrude. The anchor bolts are positioned within the frame, and concrete is poured. Once the concrete is dried and set, the anchor bolts are held secured in place. Many problems occur with placing anchor bolts installed in this manner. Anchor bolts must be placed in specific locations to align with the frame of the structure. Often times, the anchor bolts are not aligned properly, as a result of the bolt being misaligned or moved out of alignment while pouring the concrete. This creates serious problems as the building structure may not be able to be secured properly, and the process of installing a replacement bolt by drilling the concrete and using epoxy to fix another bolt in place is expensive and time consuming.

To alleviate such problems, different devices have been created to secure the anchor bolts while pouring the concrete. Most methods involve securing the anchor bolt to the retainer wall. A simple method for securing the anchor bolts is to use segments of scrap wood from the worksite, usually pieces of 2×4 lumber, to create a bolt holder. This involves cutting the wood to a given length, and drilling a hole near one end for the insertion of the anchor bolt rod. This hole is placed over the anchor bolt and the other end of the board is nailed to the top surface of an adjacent wooden retainer wall. Then, to keep the holder in place, a nut must be secured to the top of the anchor bolt, and fastened to the holder. Such crude devices leave significant margins for error in the positioning and alignment of the anchor bolts which can affect critical tolerances for the structure being built. Such devices are not economical to use since workers must be taken from other tasks to construct and install the makeshift bolt holders at the work site, and because such bolt holders cannot normally be used more than once.

Other anchor bolt holders have been created to address these problems. For example, U.S. Pat. Nos. 6,922,968, 6,065,730, 5,670,076 describe anchor bolt holders which can be mass produced and more accurately attach an anchor bolt to the retainer wall. These patents also disclose holders that are marked for use with the various size foundation walls normally found at worksites. The common problem with the above anchor bolt holders is the means for attachment of the bolt holder to the retainer wall. In addition, time must be spent to clean concrete from the threads of an anchor bolt holder that is splashed upon the uncovered threads of anchor bolts held by such devices while pouring the concrete.

Another issue with anchor bolts is safety. Anchor bolts can cause severe injury to an individual, as they are a tripping hazard, and may cause a serious impact injury if one were to fall on one due to the small surface area of the anchor bolt. Because of this safety issue, many companies and local, city, or state governments have regulations requiring that the bolts be capped with a larger surface that is usually brightly colored as to prevent injury. Another problem is the time consuming effort it takes to place caps on all of the anchor bolts, which is presently a separate operation since existing anchor bolt holders must first be removed before the caps can be installed. As much as an entire day may be lost at a given jobsite removing the crude anchor bolt holders, and placing anchor bolt caps on each exposed anchor bolt. The combination of any or all of the above mentioned problems can cause serious delay in projects as well as increase the amount of labor spent on a given project.

It is therefore desirable to provide an anchor bolt holder that securely attaches an anchor bolt to the retainer wall, yet provides for easy attachment and removal means. It is further desirable to provide an anchor bolt holder that is conspicuous to workers that can remain on the anchor bolt from the time of placement of the anchor bolt until the time when the anchor bolt is used to secure the frame of the structure to the foundation. It is also desirable to provide anchor bolt holders that may be used over and over. It is also desirable to provide anchor bolt holders for anchor bolts of different sizes, lengths and cross sections.

### SUMMARY OF THE INVENTION

The present invention addresses these problems by providing two-piece anchor bolt clip and holder devices that may be easily engaged with and disengaged from anchor bolts used in building construction, and methods of using them. Embodiments of the invention include a bolt-engaging piece or clip that may be brightly colored and that is designed for temporary but secure attachment to an anchor bolt. A separate housing that may also be brightly colored is provided that fits over and temporarily but securely attaches to the clip. Embodiments of the housing are provided with a pivotally or hingedly attached extension piece or bracket. Embodiments of these brackets are designed for temporary but secure engagement with framing walls or other nearby structures to provide stability to the housing, clip and anchor bolt.

The clips of the present invention are in the form of sleeves having an open ended hollow body with a central axis, a plurality of inwardly extending flanges at one end for engagement with the threads or edges of an anchor bolt, and one or more outwardly extending exterior studs.

The body of the sleeves is preferably of a generally cylindrical shape, having a round cross-section, but may also be provided in any other suitable shape, depending on the size and shape of the anchor bolts to be engaged. Alternative cross-sections may be without limitation generally oval; elliptical, hexagonal, octagonal, square, rectangular, and the like. The clips may be of different sizes so as to be engaged with anchor bolts of different sizes (e.g. ⅜″, ½″, ⅝″, ¾″, etc.). Clips of different sizes may be provided in different colors, making it easy for the user to identify which clip goes with which size of anchor bolt. For example, and without limitation, clips for ⅝″ anchor bolts may be provided in yellow, with clips for ¾″ anchor bolts being provided in blue. In this way, a user knows to look for yellow clips when dealing with ⅝″ bolts, and blue clips when dealing with ¾″ bolts.

The flanges on the clips are made of a durable but slightly resilient material such as plastic, and are positioned so that they extend inwardly towards the central axis of the clip. In the preferred cylindrical embodiment, these flanges extend radially inward part way toward, but not reaching the central axis. In the preferred embodiment and other embodiments, the flanges may also extend upward as well as inward, for easy installation. It is to be appreciated that in alternative embodiments, the flanges may extend inward at the same or different angles for different gripping effects.

In the preferred embodiment, four spaced apart flanges are provided in opposing pairs across the central axis from each other, although any suitable number of flanges may be used so long as they are positioned so as to provide opposing or complementary forces to temporarily engage the side or threads of an anchor bolt placed along the central axis. For example, and without limitation, three equally spaced apart flanges may be provided. In some embodiments, an inwardly pointing ridge or teeth may be provided at the end of one or more of the flanges to fit into the threads of, or otherwise securely engage, the anchor bolt. The flanges are positioned to be tight enough to firmly engage the anchor bolt, even if it has no threads or very shallow threads. In some embodiments, the individual flanges on a given clip may have different lengths so as to facilitate easier screwing and unscrewing engagement with anchor bolts having helical threads thereon. Similarly, the lengths of the ridges/teeth on the flanges of a given clip may also be different from each other.

The exterior of the clip bodies of the present invention are provided with one or more outwardly extending studs or knobs, preferably of the same color as the clip. These knobs are designed for temporary engagement with corresponding slots in embodiments of housing structures that fit over the clips. It is to be appreciated that clips of various sizes may be attached to housings that are the same size. Thus, the positioning of the studs or knobs on the clips should generally be the same for the various sized clips so that any of the clips may be engaged to the same housing. It is also to be appreciated that once a clip is engaged with a housing, a portion of the clip and/or the knobs should be visible. If different sized clips are of different colors, this makes it easy for the user to identify the size of the clip that has been inserted into the housing.

In use, a clip is chosen having a cross-section corresponding to the anchor bolt to which it will be attached. The clip is then positioned so that its central axis lines up with that of an anchor bolt. The clip is then slid, screwed or ratcheted down over the anchor bolt such that the flanges engage the sides of the bolt and, if provided, the ridges or teeth engage the threads on edges of the bolt. As the clip is moved down along the anchor bolt, the flanges may ratchet over the threads or edges (e.g. rebar) of the bolt until a selected position is reached. Alternatively, the clip may be rotated (screwed) downwardly around threads on the anchor bolt until it reaches a desired position. The outer housing is then engaged with the stud(s) of the clip as discussed more fully below. The clips of the present invention may be provided in bright colors such as red, orange or yellow to distinguish their different sizes, and to make them highly visible even when coupled to a housing structure. Removal of a clip is accomplished by pulling it back up or rotating it in the opposite direction (unscrewing) along the anchor bolt. The removal may bend or break the flanges on the clip, in which case it may be discarded. If the flanges survive the removal process, the clip may be re-used.

The clips of the present invention are designed for temporary but secure engagement with an outer housing. Embodiments of the outer housings of the present invention have an open-ended hollow sleeve having a central axis. As with the clips, the body of the housing is preferably cylindrical in shape having a circular cross-section, although any other suitable shape may be used, depending on the size and shape of the clips and anchor bolts to be engaged. Alternative cross-sections may be without limitation generally oval, elliptical, hexagonal, octagonal, square, rectangular, and the like. The housing is also preferably brightly colored. The lower end of the housing is open so as to receive the anchor bolt and clip; the upper end of the housing is preferably closed, but may be open to allow for engagement with elongated anchor bolts.

The lower end of the housing body is provided with one or more slots for receiving corresponding knobs on the clips. Embodiments of the slots have an L-shaped or other configuration that-allows each knob to be received into its corresponding slot as the housing is lowered over the clip. In these embodiments, the knob travels upward in the slot as the housing is lowered over the clip. The housing may then be rotated, causing each knob to travel into a different segment of its corresponding slot. This twisting motion temporarily locks the knob into the slot, preventing the housing from being easily separated from the clip. In the preferred embodiment, clips of various sizes are designed such that their knobs are in the same locations, allowing any of the clips to be attached to the same sized housing. This allows a variety of differently sized anchor bolts to be engaged with their respective clips, and then attached to housings of a uniform size. In alternative embodiments, the knobs of the present invention may have different sizes, shapes and/or lengths, with the corresponding slots having similar complimentary widths and contours. In some embodiments, the knobs and/or slots may also be provided with hooks, notches or grooves to more securely engage the knobs in the slots.

In some embodiments, the housing is provided with one or more legs that extend laterally and/or radially outward and away from the body of the housing. In the preferred embodiment one such leg is provided. The leg(s) include a downwardly protruding section or foot. The foot establishes a distance by which the bottom of the' housing is separated from the top of the concrete foundation and/or the top of adjacent framing. This separation provides a gap (preferably but not necessarily ⅜″ in height) between the bottom of the housing cylinder and the concrete around the anchor bolt. This allows access to a trowel or other concrete tools so that the concrete immediately adjacent to the anchor bolt may be worked as it dries. It is to be appreciated that the clip should also be positioned above this gap to allow access to the edge of the anchor bolt underneath the clip/housing.

In the preferred embodiment, a hingedly or pivotally attached extension is provided on the leg(s). In other embodiments this extension may be attached directly to the body of the housing or to the foot. In all embodiments, the extension is designed to be moved outward using a hinge, pivot or other junction so that it extends away from the housing body. The extension may be of any suitable length, and is designed to be extended far enough to reach an adjacent framing board on other fixed structural component for engagement therewith. Ordinarily, the framing members for the concrete curbs where anchor bolts are installed are generally not more than 12 inches apart, so an extension of this length would be more than sufficient, although greater or lesser lengths may also be appropriate. When not in use, the extension may be folded up against the body, the end fitting into an optional notch on the body. In some embodiments the extension is provided with one or more openings through which nails, screws, rivets, pins, clamps or other fasteners may be passed. Such fasteners may be driven or extended through the opening(s) and into the framing board over which the extension has been folded open. This allows the extension to be secured to the board, securing the position of housing, the clip, and the anchor bolt inside. More than one leg and/or extension may be provided to provide alternatives for engagement with an adjacent structural component (framing board, pipe or other fixed structural component), or to allow engagement with multiple components for more stability. It is to be appreciated that in some situations, a clamp or other fastener may be attached to or passed through an opening on the extension and engaged with a pipe or other structural member that would be damaged by a screw or nail.

In some embodiments, the extension(s) is provided with a series of tiers or segments in a stair-step configuration (extending upward or downward). This allows for engagement with framing wall board that may be taller or shorter than (above or below) the bottom edge of the housing. In most embodiments the extension(s) are designed to extend out well beyond the edge of the framing wall board. This provides an outwardly protruding lip or tab that may be utilized to disengage the extension from the framing wall board. If for example the extension has been attached to the framing board by hammering one or more nails through one or more openings on the extension, an upward force (from a hammer or the user's shoe) exerted on the outwardly protruding lip or tab may be used to loosen and/or disengage the nail(s) thereby releasing the extension. Of course, this removal method may not be appropriate in other embodiments where screws or clamps have been used. In those cases, the screw(s) may be reversed or the clamps uncoupled to disengage the extension from a structural member.

It is to be appreciated that once the clip is ratcheted or screwed into position down the anchor bolt, it may be rotated around the anchor bolt in order to bring a leg and/or extensions on the housing into a position near a structural component to allow the extension to reach the component for engagement therewith. In other embodiments, multiple extensions may be provided to make it easier to position an extension for engagement with a nearby structural component, or to engage with more than one structural component

In some embodiments the extension(s) may be provided with pre-installed nails, pins, spikes, tacks or bolts allowing the extension(s) to be engaged to a framing board by simply hammering or pounding on the extension to force these pre-installed nails into the framing board.

In use, a clip is screwed, ratcheted or slid down the anchor bolt to a position that will be above the upper plane of the concrete foundation to be poured. The housing is then placed over the anchor bolt and clip, with the knob(s) of the clip fitting into corresponding slot(s) on the housing. The housing is then rotated to couple the housing to the clip with the knobs traveling into the slots on the housing, temporarily locking the clip and housing together. The housing, clip and bolt are thereafter moved as a unit until a pivotally attached extension on the housing is optimally positioned for engagement with a nearby structural component. The extension is then folded out and against the structural component and engaged with it. This may be accomplished by driving on one or more nails through holes on the extension and into a framing board, by pounding a spiked section of the extension into a framing board, by clamping the extension to a pipe, or the like. Once secured, the extension, housing and clip serve to hold the anchor bolt in its proper place (hanging in space) until the concrete is poured, worked and allowed to harden. It is to be appreciated that multiple anchor bolts may be positioned in this way, followed by a single concrete pour which sets them all in place.

During the installation process, a gap is established between the bottom of the coupled clip-housing assembly and the upper plane of the concrete to be poured, allowing a trowel or other tools to be inserted underneath the assembly and right up next to the anchor bolt to smooth or otherwise work with the surface of the freshly poured concrete. When the concrete has hardened, the extension may be removed from the framing board by kicking or upwardly pounding on a protruding tab of the extension to loosen the spike or nails used to engage it with the board. In alternative embodiments, screws may be unscrewed, or clamps unclamped, etc. to disengage the extension from the adjacent structural member. The extension(s) are then folded up and may be clipped against housing, or removed.

The brightly-colored housing (with the internal clip) may be removed at this point, but is preferably left in place to show the location of the anchor bolt to workers who continue construction of the building. The brightly colored housing now serves as a warning device identifying the location of the anchor bolt, and serving to help prevent workers from tripping over or impaling themselves on the anchor bolt. The housing and clip are eventually removed when the anchor bolt is put into use as part of the building construction. The housing is uncoupled from the clip by rotating it in the opposite direction to unlock the knobs from the slots. The housing may then be lifted from the bolt and removed. The clip may then be unscrewed, ratcheted or slid up to the top of the anchor bolt and removed. The housing assembly and/or clip may be re-used multiple times and provide for reliable and secure positioning and identification of anchor bolts before, during and after concrete is poured.

The pivot/hinge attaching the housing to the extension may be provided in many different forms. In one embodiment, the hinge may be formed using a pinned rod that is connected to either to the housing or the leg, allowing the independent movement of the hingedly attached extension. In another embodiment, the extension may include an integrated rod, and the housing has complementary slots for receiving parts the rod allowing the rod to rotate within the slots as a hinge. In another alternative embodiment, the extension may be integrated into the housing, with the hinge formed from a flexible portion of plastic or rubberized material allowing for movement in a vertical manner.

It is therefore an object of the present invention to provide devices for reliably and securely holding building anchor bolts in place while concrete is poured around them.

It is a further object of the present invention to provide warning devices for engagement with building anchor bolts to identify their locations to persons at the building construction site, to prevent tripping over or impalement on anchor bolts.

It is a further object of the present invention to provide simple and reliable methods for temporarily supporting anchor bolts while concrete is poured around them.

It is a further object of the present invention to provide methods and apparatus for easily attaching and removing a devices that may be temporarily attached to anchor bolts when concrete is poured around them.

It is further object of the present invention to provide anchor bolt holders having at least one leg defining a gap between the bottom of the holder and the upper plane of the concrete to be formed, the gap allowing access by a trowel or other concrete working tools.

It is further object of the invention to provide an anchor bolt holders that are reusable.

Additional objects of the invention will be apparent from the detailed descriptions and the claims herein.

### BRIEF DESCRIPTION OF THE DRAWINGS

FIG. 1 is a perspective environmental view of one embodiment of the present invention installed over an anchor bolt after concrete has been poured.

FIG. 2 is a side cross-sectional view along line 2-2 of FIG. 1.

FIG. 3 is a partially exploded view of an embodiment of the invention illustrating a clip attached to an anchor bolt prior to insertion into a housing.

FIG. 4A is a side perspective view of one embodiment of a housing of the present invention with the extension folded down.

FIG. 4B is a side perspective view of one embodiment of a housing of the present invention with the extension folded up.

FIG. 5 is a side elevational view of an embodiment of the present invention.

FIG. 6 is a side perspective view of one embodiment of the present invention.

FIG. 7 is a bottom plan view of one embodiment the present invention.

FIG. 8A is a front elevational view of one embodiment of the present invention.

FIG. 8B is a side elevational view of the embodiment of FIG. 8A.

FIG. 9A is a left side elevational view of one embodiment of the present invention.

FIG. 9B is a rear elevational view of the embodiment of FIG. 9A.

FIG. 9C is a right side elevational view of the embodiment of FIG. 9A.

FIG. 9D is a bottom plan view of the embodiment of FIG. 9A.

FIG. 9E is a perspective view of the embodiment of FIG. 9A.

FIG. 10A is a left side elevational view of one embodiment of the present invention.

FIG. 10B is a bottom plan view of the embodiment of FIG. 10A.

FIG. 10C is a cross-sectional view along line A-A of FIG. 10B.

FIG. 10D is a left side elevational view of the embodiment of FIG. 10A showing a housing separated from a clip.

FIG. 10E is a perspective view of the embodiment of FIG. 10A.

FIG. 11A is a left side elevational view of one embodiment of the present invention.

FIG. 11B is a rear elevational view of the embodiment of FIG. 11A.

FIG. 11C is a right side elevational view of the embodiment of FIG. 11B.

FIG. 11D is a top plan view of the embodiment of FIG. 11A.

FIG. 11E is a perspective view of the embodiment of FIG. 11A.

FIG. 12A is a top plan view of an embodiment of an extension of the present invention.

FIG. 12B is a side elevational view of the embodiment of FIG. 12A.

FIG. 12C is a top plan view of the embodiment of FIG. 12A.

FIG. 12C is a perspective view of the embodiment of FIG. 12A.

FIG. 13A is a side view of an embodiment of a clip of the present invention.

FIG. 13B is a top plan view of the clip of FIG. 13A.

FIG. 13C is a perspective view of the clip of FIG. 13A.

FIG. 13D is a side view of an embodiment of a clip of the present invention.

FIG. 13E is a top plan view of the clip of FIG. 13D.

FIG. 13F is a perspective view of the clip of FIG. 13D.

FIG. 14A is a side view of an embodiment of a clip of the present invention.

FIG. 14B is a top plan view of the clip of FIG. 14A.

FIG. 14C is a perspective view of the clip of FIG. 14A.

FIG. 15A is a side view of an embodiment of a clip of the present invention.

FIG. 15B is a top plan view of the clip of FIG. 15A.

FIG. 15C is a perspective view of the clip of FIG. 15A.

FIG. 16A is a side view of an embodiment of a clip of the present invention.

FIG. 16B is a top plan view of the clip of FIG. 16A.

FIG. 16C is a perspective view of the clip of FIG. 16A.

FIG. 17A is a side view of an embodiment of a clip of the present invention.

FIG. 17B is a top plan view of the clip of FIG. 17A.

FIG. 17C is a perspective view of the clip of FIG. 17A.

FIG. 18A is a side perspective view of an embodiment of a clip of the present invention.

FIG. 18B is a bottom perspective view of the clip of FIG. 18A.

### DETAILED DESCRIPTION

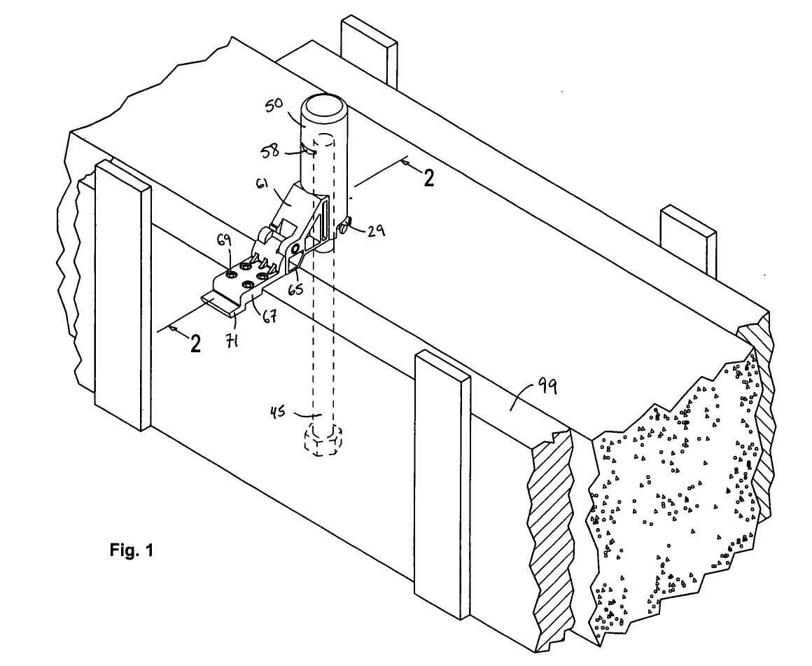

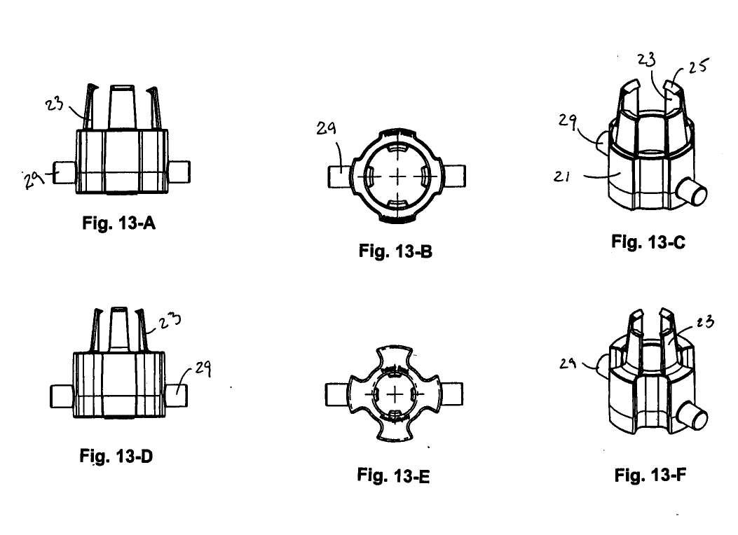

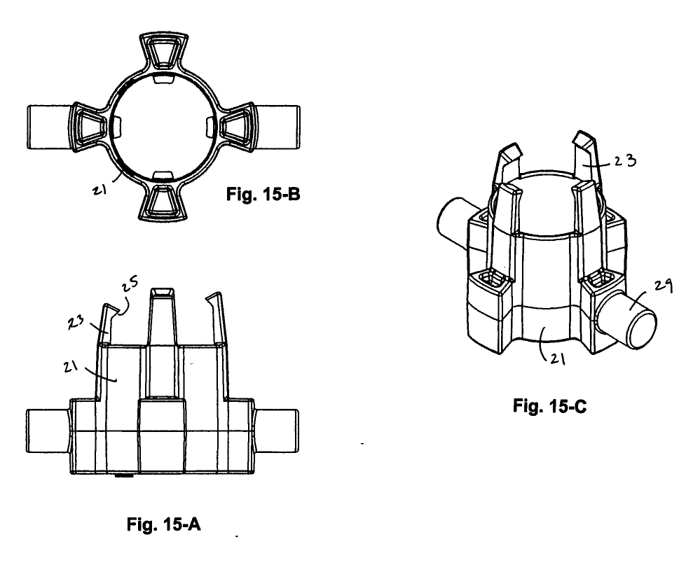

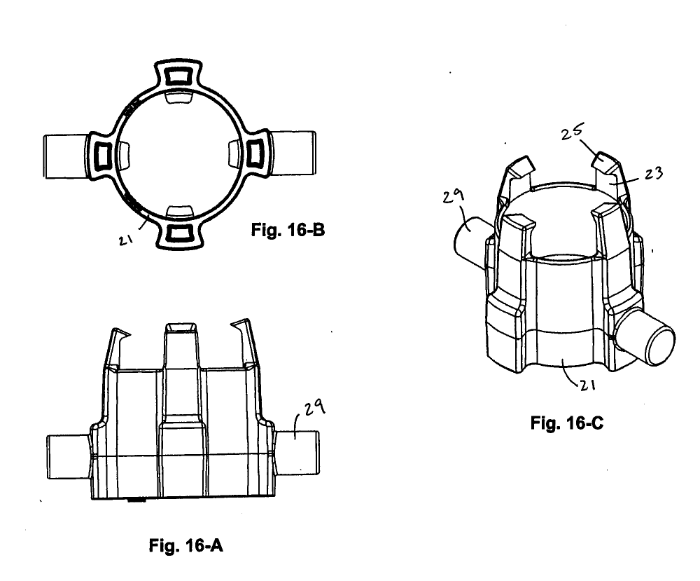

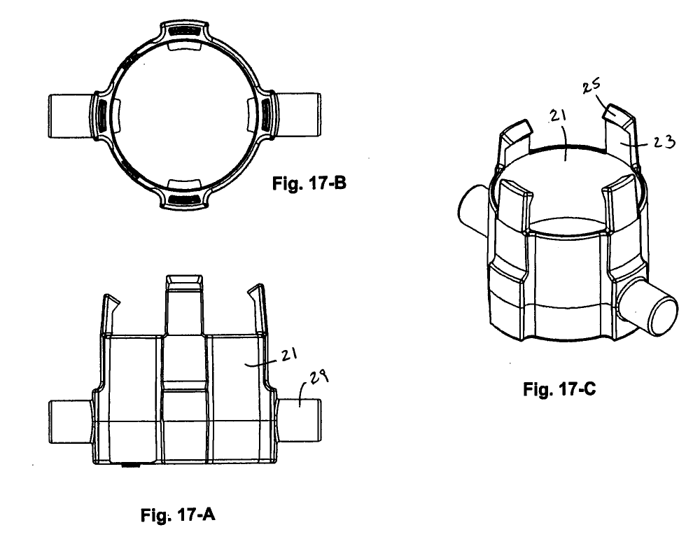

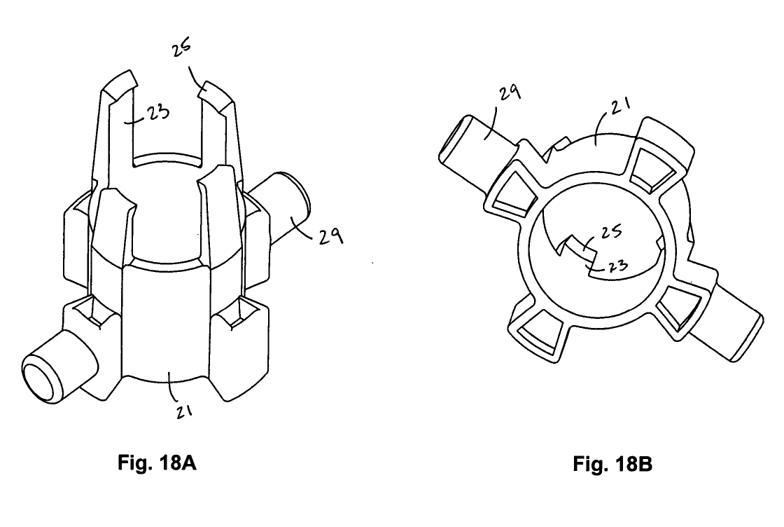

Referring to the drawings wherein like reference characters designate like or corresponding parts throughout the several views, and referring particularly to FIGS. 1, 2 and 10D, it is seen that each apparatus of the present invention includes a clip 21 that engages with a housing 50. Each clip 21 in the form of a hollow sleeve preferably of a generally cylindrical shape having a central axis, the clip being designed to engage an anchor bolt 45 that is extended upward into the clip through said axis. Clips 21 may also be provided in any other suitable shape, depending on the size and shape of the anchor bolts 45 to be engaged. Examples of some different embodiments are illustrated in FIGS. 13-17 for engagement with different anchor bolts 45 commonly used in construction sites including, but not limited to, ½, ⅝, ¾, ⅞, 1, 1⅛, 1¼ inch and othersized anchor bolts 45. Clips of different sizes may be provided in different colors, making it easy for the user to identify which clip goes with which size of anchor bolt.

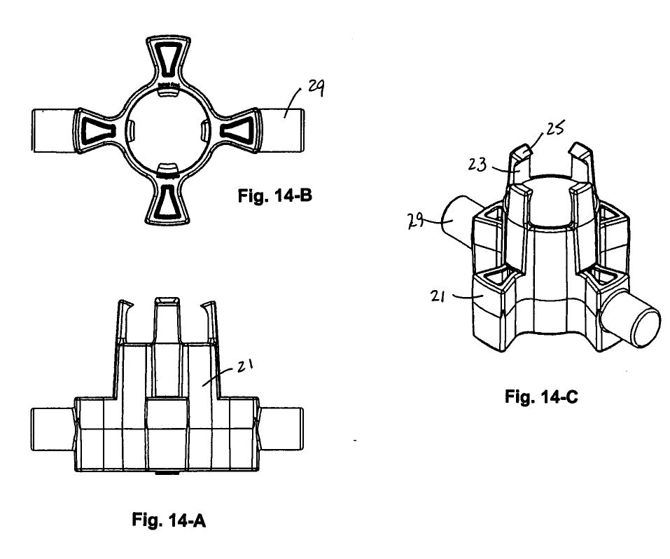

Each clip 21 includes a plurality of flanges 23 at one end made of a durable but slightly resilient material. Flanges 23 extend out from the end and radially inward toward said the central axis. Flanges 23 are designed to press against the edges of an anchor bolt 45 in order to temporarily secure clip 21 to bolt 45. One or more of the ends of flanges 23 may be provided with inwardly extending optional ridges or teeth 25 that are designed to engage the threaded section 46 of an anchor bolt 45, if present, or to press firmly against the shaft of bolt 45 if it has no threaded section. The illustrated embodiments depict clips 21 having four flanges, although any suitable number of flanges may be employed. In some embodiments, the individual flanges 23 on a given clip 21 may have different lengths so as to facilitate easier screwing and unscrewing engagement with threaded anchor bolts 45. Similarly, the ridges/teeth 25 on the flanges of a given clip 21 may also be of different sizes. The exterior of the clip bodies 21 of the present invention are provided with one or more outwardly extending studs or knobs 29. Knobs 29 are designed for temporary engagement with corresponding slots 55 in the housing structures 50 that fit over the clips 21. In the preferred embodiment, clips 21 are provided in various sizes to be attached to housings 50 of the same size. This requires that the positioning of the knobs 29 be generally the same for the various sized clips 21 (see FIGS. 14-17) so that any of the differently sized clips 21 may be engaged to the same housing 50. Clips 21 are preferably brightly colored.

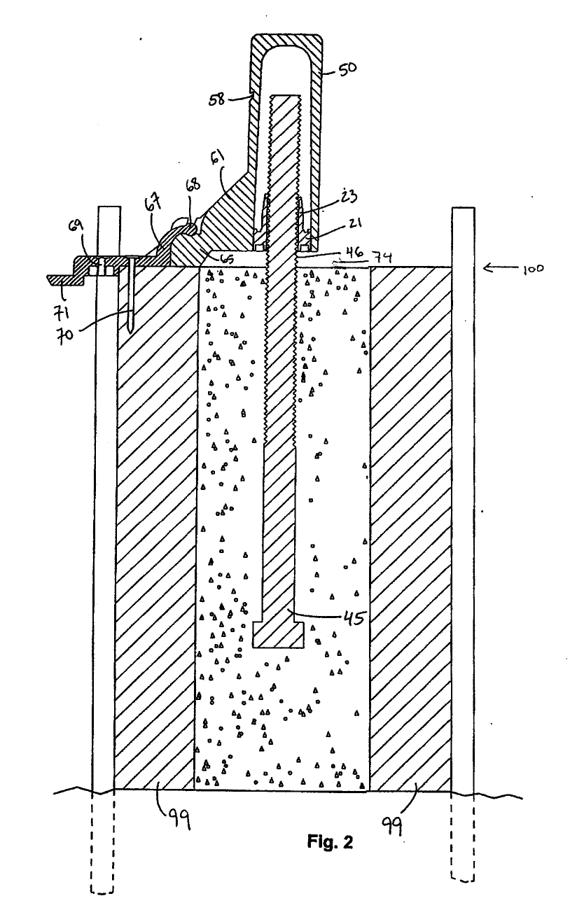

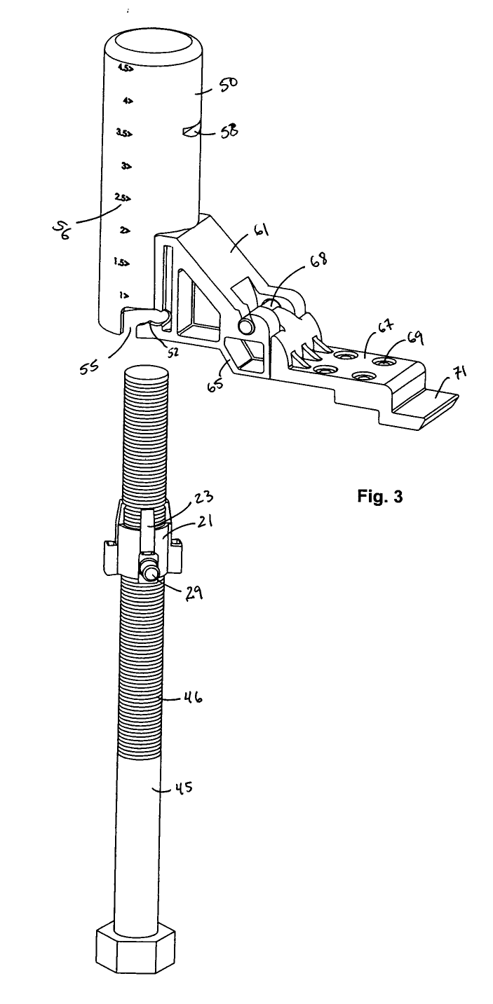

The clips 21 of the present invention are designed for temporary but secure engagement with an outer housing 50. Each housing 50 is in the form of an elongate hollow sleeve or column having a central axis that is designed to extend around and over an anchor bolt 45. Each housing 50 is preferably of a generally cylindrical shape, and should be of sufficient size to accept varying sized clips 21 and corresponding anchor bolts 45. In alternative embodiments, the housing 50 of the invention may be made of varying cross-sections to correspond with different sized clips 21. Housing 50 may be open at both ends in order to receive longer bolts 45, but in the illustrated exemplary embodiments, the upper end is closed. In such embodiments, the height of housing 50 should be sufficient to receive the length of the portion of the anchor bolt 45 that extends above the surface of the retaining wall 99 which ordinarily defines the plane of the finished concrete foundation, once poured, as shown in FIG. 2. In alternative embodiments, housing 50 may be provided with external measuring indicia 56 to help the user easily and consistently position a clip and housing on each anchor bolt.

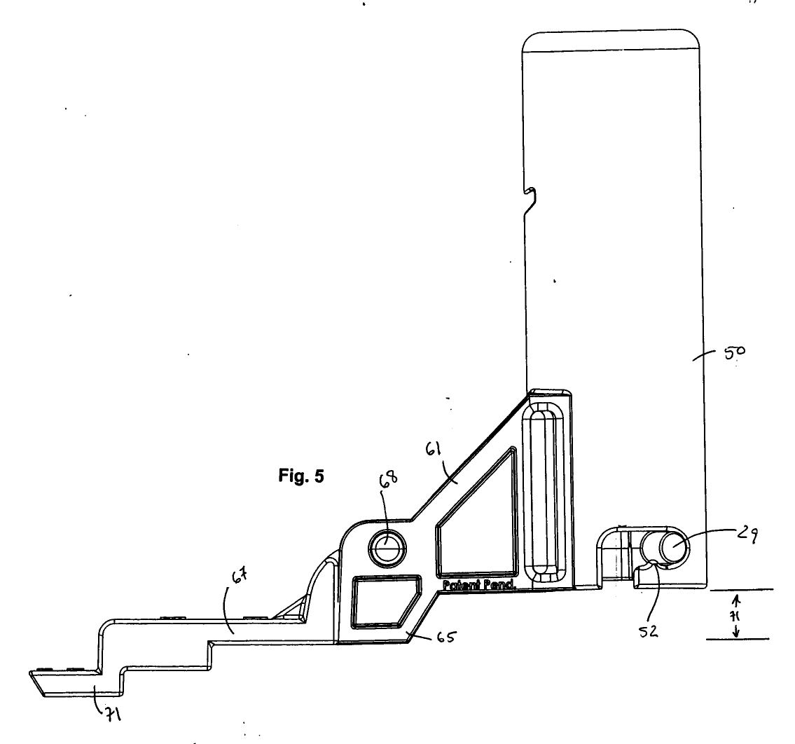

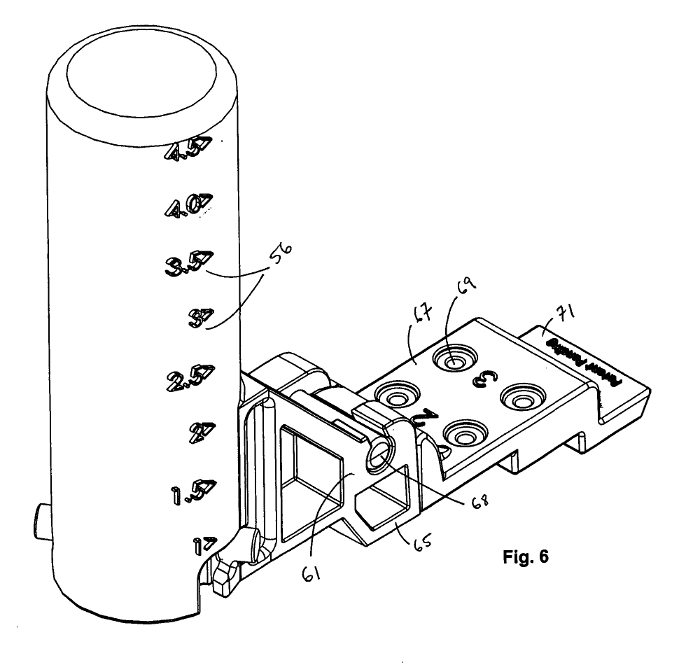

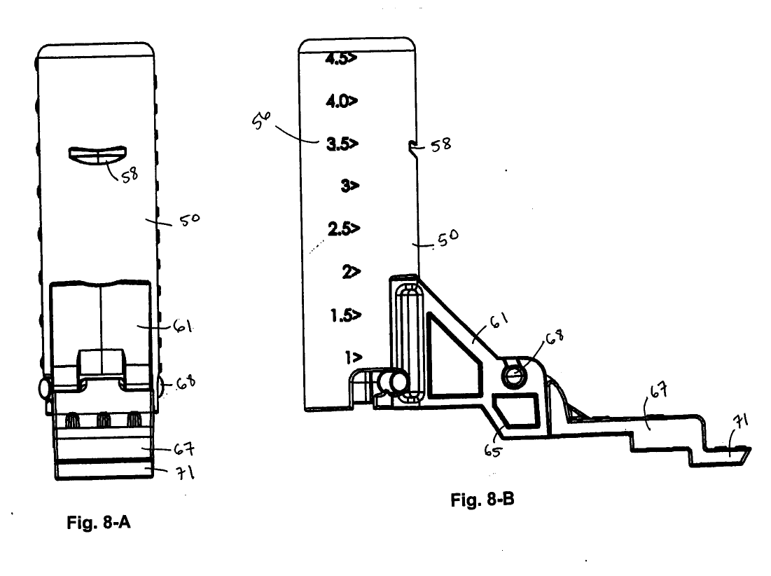

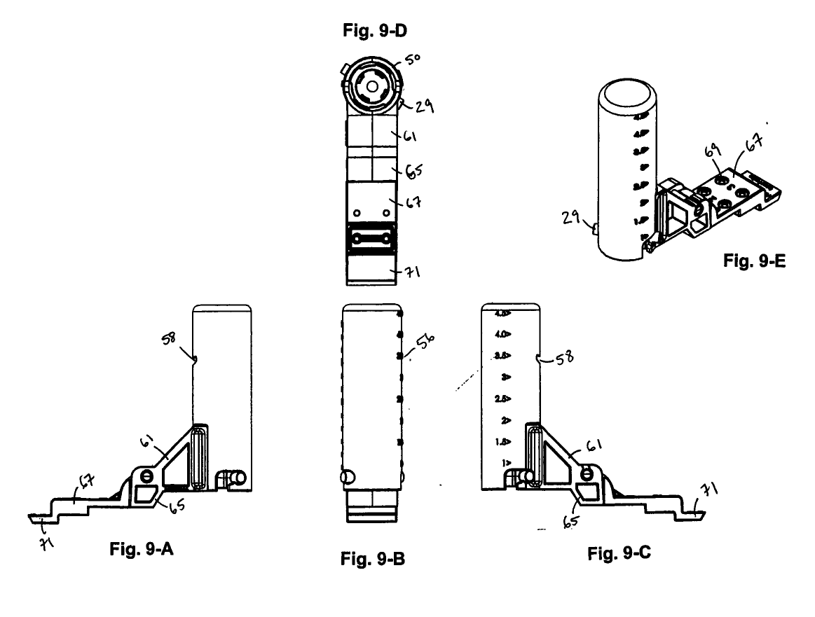

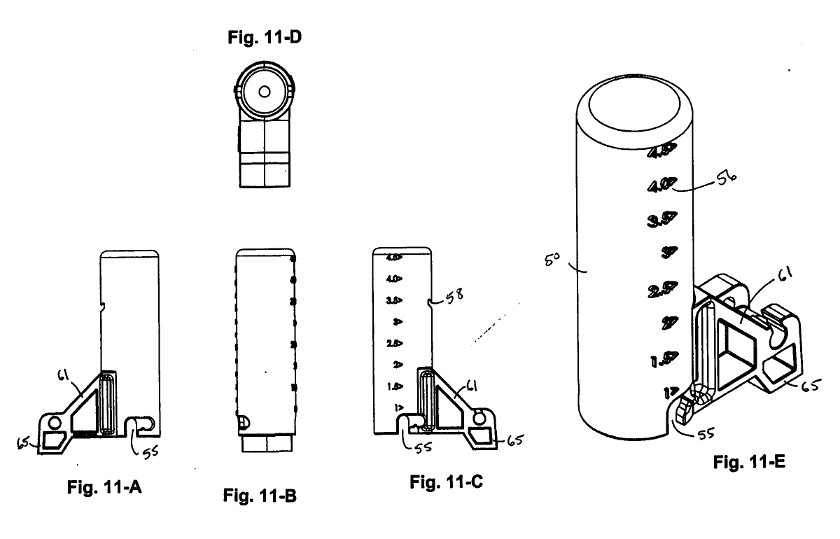

The lower end of the housing 50 is provided with one or more slots 55 for receiving knobs 29 on clips 21, as shown in FIGS. 11A-E. The illustrated exemplary embodiments of the slots 55 show an L-shaped configuration, but any suitable engagement configuration may be used. The illustrated slots 55 allow each knob 29 to be received into the corresponding slot 55 as the housing 50 is lowered over the clip 21. In these embodiments, the knob 29 travels upward in the slot 55 as the housing is lowered over the clip. The housing may then be rotated, causing each knob 29 to travel into a different segment of its corresponding slot. This twisting motion temporarily locks each knob 29 into its corresponding slot 55, preventing the housing 50 from being easily separated from the clip 21. This engaged condition is shown in FIGS. 5-6 and 8-10. It is to be appreciated that the knobs of the present invention may have different sizes, shapes and/or lengths, and that the corresponding slots may have similar complimentary widths and contours. In some embodiments, the knobs and/or slots may also be provided with hooks, ridges 52 or grooves to more securely engage the knobs in the slots.

Housing 50 is provided with one or more legs 61 that extend outward and away from the body of the housing. In the illustrated exemplary embodiments, legs 61 include a laterally extending portion and an angled portion, although have any suitable configuration may be used. Each leg 61 also includes a downwardly protruding section or foot 65. In the illustrated exemplary embodiments, each foot 65 includes a lateral portion and an angled portion, although any suitable configuration may be used. The foot 65 establishes a distance by which the bottom of the housing 50 is separated from the top plane 100 of the concrete to be poured. This is usually but not always the same as the top of adjacent framing 99. This separation provides a gap 74 between the bottom of the housing 50 and the concrete around the anchor bolt. Gap 74 may be of any suitable size to allow access by a trowel or other concrete tools to the concrete immediately adjacent to the anchor bolt so that it may be worked as it dries. It is to be appreciated that the bottom of clip 21 is also positioned above gap 74 to allow access to the edge of the anchor bolt 45 underneath the clip and housing.

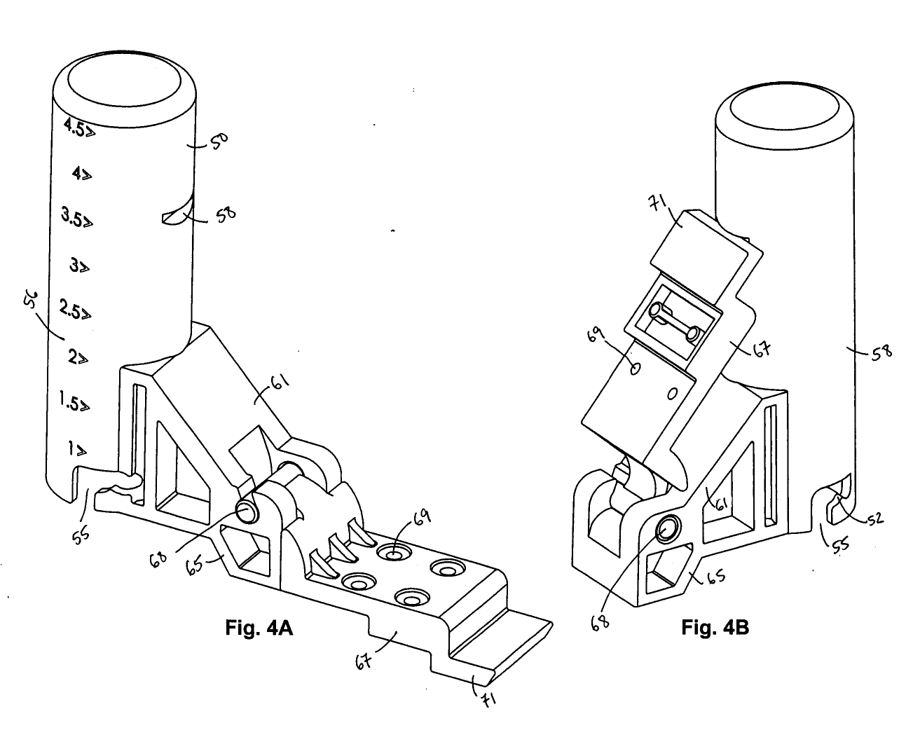

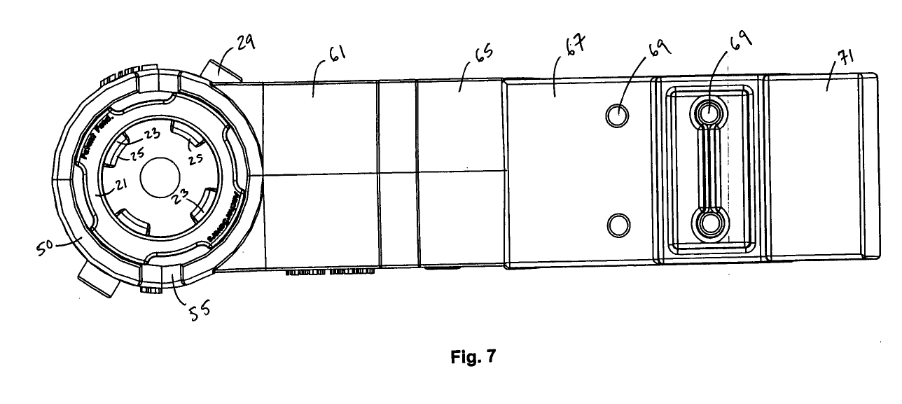

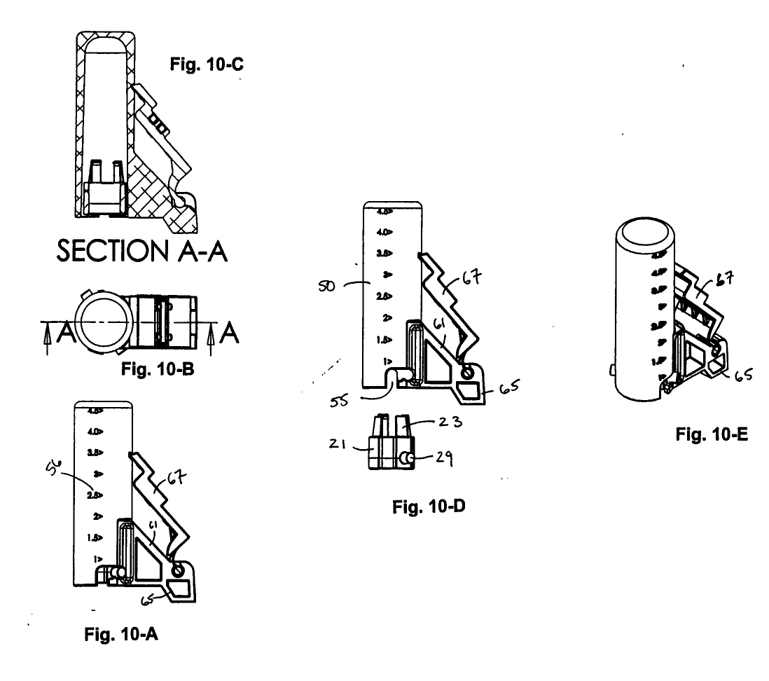

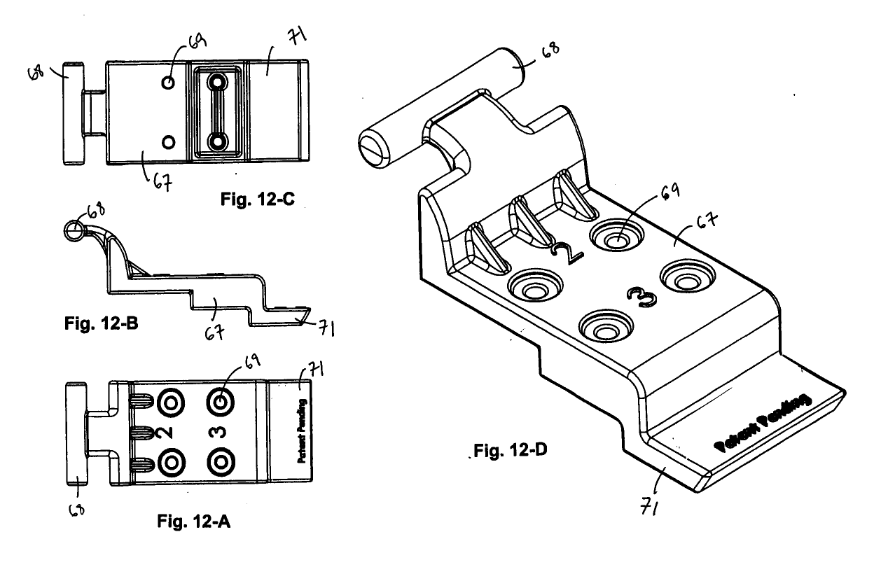

A movable (preferably hinged or pivotally attached) extension 67 is provided on each leg 61 or foot 65. In alternative embodiments such extensions may be attached directly to the body of the housing 50. It is to be appreciated that one or more extensions may be provided, whether attached to a leg 61, a foot 65, and/or to housing 50. Each extension 67 is movably attached, such as by pivot 68, allowing the extension 67 to be extended or retracted. In the illustrated embodiments, this is an upward or downward movement. Each extension 67 is designed so that when it swings down it extends outwardly (usually radially) away from housing 50. Extension 67 should be of sufficient length to reach an adjacent framing board 99 or other fixed structural component when extended out, for engagement with that component. Extension lengths ranging between one and 24 inches are contemplated. Outward positions of extension 67 are shown in FIGS. 1-2, 5-8, 8A-B, and 9A-E. When not in use, the extension 67 may be folded up against the housing 50. An optional notch 58 may be provided in housing 50 for receiving the end of extension 67, as shown in FIG. 4A-B. Upward positions of extension 67 are also shown in FIGS. 10A-E. Isolated views of an extension 67 are illustrated in FIGS. 12A-D. More than one leg 65 and/or extension 67 may be provided for more alternatives for engagement with an adjacent structural component (e.g., framing board 99, a pipe, or some other fixed structural component), or to allow engagement with multiple components for more stability (such as where two framing boards 99 form a corner).

In the illustrated exemplary embodiments, extension 67 is provided with one or more openings 69 through which one or more nails, screws, rivets, pins, clamps or other fasteners 70 may be passed. This allows the extension 67 to be secured to a framing board 99 or other component. In the illustrated exemplary embodiment shown in FIGS. 1-2, extension 67 has been folded out, and a nail 70 has been driven through one of openings 69 into board 99. This engagement temporarily secures the position of the extension 67, foot 65, leg 61, housing 50, clip 21, and the anchor bolt 45 inside so that concrete may be poured around the anchor bolt. It is to be appreciated that in some situations, a clamp or other fastener may be attached to or passed through one or more of openings 69 and engaged with a pipe or other structural member that would be damaged by a screw or nail.

In some embodiments, extension 67 may be provided with a series of tiers, as illustrated in FIGS. 12A-D. This configuration provides openings 69 at different levels, allowing for engagement with framing wall boards 99 that may be at different levels above or below the bottom edge of the housing 50. In many such cases, foot 65 may not reach or touch the framing board 99, although one of the segments of extension 67 will reach. In most embodiments extension 67 is designed to extend beyond the edge of the framing wall board 99. This provides an outwardly protruding lip or tab 71 that may be utilized to disengage the extension 67 from the framing wall board 99 or other structural member. In the illustrated embodiment shown in FIGS. 1-2, extension 67 has been attached to a framing board 99 with nail 70. Extension 67 may be removed by the exertion of an upward force on the outwardly protruding tab 71 to loosen and/or disengage the nail(s) 70 from board 99, thereby releasing the extension 67. In those cases where one or more screws, clamps or other devices 70 have been used for engagement to a structural member, the screws may be reversed or the clamps uncoupled, etc. to disengage the extension 67 from the structural member.

In some embodiments extension 67 may be provided with pre-installed nails, pins, spikes, tacks or other fasteners allowing the extension 67 to be engaged to a framing board 99 by simply hammering or pounding on the extension 67 to force these pre-installed fasteners into the framing board 99. Removal is accomplished using upward force on tab 71. In other embodiments, extension 67 may be provided with pre-installed screws, clamps or other devices for engagement with one or more structural members.

In use, a clip 21 is chosen having a cross-section (and possibly a color) corresponding to the anchor bolt 45 to which it will be attached. Clip 21 is then engaged to a housing 50, by fitting knob(s) 29 of the clip 21 into corresponding slot(s) 55 on the housing 50. The housing is then rotated to couple the housing to the clip, with the knobs 29 traveling into the slots 55 on the housing, temporarily locking the clip and housing together. The clip-housing assembly is taken to the location at the job site where it is to hold an anchor bolt. Extension 67 is folded out, the clip-housing assembly is moved to the desired position, and one or more fasteners such as a nail 70 are used to engage extension 67 with a structural component such as board 99 to hold it in place. The clip-housing assembly 21/50 is now securely attached to a structural component 99 at the desired location for an anchor bolt 45, awaiting insertion of the anchor bolt it is to hold.

The measuring indicia 56 on the outside of the housing may be used to determine how far an anchor bolt 45 will be extended up into such a mounted clip-housing assembly. For example, if the user knows the bolt is to extend 3½ inches up into the housing, the user may place the anchor bolt 45 against the measuring indicia 56 on the side of housing 50 so that the top of the bolt is at the 3½ inch mark. The user may then grasp the anchor bolt 45 below the housing such that 3½ inches of the bolt extend above the user's hand, and then without releasing the grasp, insert the bolt into the central axis of clip 21, ratcheting it upward until the user's hand is blocked by the bottom of the housing 50. The flanges 23 engage the sides (e.g., rough rebar) of the bolt 45 and, if provided, the ridges or teeth 25 engage the threads 46 on the edges of the bolt. The bolt 45 will then be securely engaged, extending approximately 3½ inches into the clip-housing 21/50 as desired, and suspended in space at the location where concrete is to be poured around it. This measuring method may be quickly and easily repeated (or changed, as necessary) for other anchor bolts to be installed using the clip-housing assemblies. Of course, the measuring indicia need not be used, and the anchor bolt 45 may simply be inserted into the clip-housing assembly 21/50 as desired by the user.

In general, an anchor bolt 45 is slid, screwed or ratcheted up into clip 21 such that the flanges 23 engage the sides of the bolt 45. The clip may be moved up or down along the anchor bolt 45 until it reaches a desired position above the upper plane 100 of the concrete foundation to be poured. A housing 50 is engaged with clip 21. This is accomplished by placing housing 50 over the clip 21, with knob(s) 29 of the clip 21 fitting into corresponding slot(s) 55 on the housing 50. The housing is then rotated to couple the housing to the clip, with the knobs 29 traveling into the slots 55 on the housing, temporarily locking the clip and housing together. The housing and clip may thereafter be moved as a unit. An anchor bolt 45 may be engaged with clip 21 before or after it is coupled to housing 50.

The coupled housing-clip assembly is then rotated to position one or more of the pivotally attached extension(s) 67 for engagement with a nearby structural component, such as a frame board 99. Extension 67 is then folded out and against the structural component and engaged with it. This may be accomplished by driving on one or more nails 70 through holes 69 on the extension and into the framing board 99, by pounding a spiked section of the extension into a framing board, by clamping the extension to a pipe, or the like. Once secured, the extension, housing and clip are available to receive and hold an anchor bolt 45 in place while concrete is poured, worked and allowed to harden. In some embodiments, multiple extensions 67 may be provided to make it easier to position an extension for engagement with a nearby structural component, or to engage with more than one structural component.

During the installation process, a gap 74 is established between the bottom of the coupled clip-housing assembly and the upper plane of the concrete to be poured, allowing a trowel or other tools to be inserted underneath the assembly and right up next to the anchor bolt to smooth or otherwise work with the surface of the freshly poured concrete.

When the concrete has hardened, the extension 67 may be removed from the framing board 99 by kicking or upwardly pounding on a protruding tab 71 of the extension to loosen the nail(s) 70 used to engage it with the board 99. In alternative embodiments, screws may be unscrewed, or clamps unclamped, etc. to disengage the extension from the adjacent structural member. Extension(s) 67 is then folded up and may be clipped against housing 50 using slot 58. The brightly-colored housing-clip assembly may be removed at this point, but is preferred to leave it in place to act as a warning device to identify the location of the anchor bolt to workers who continue construction work at the jobsite. The housing and clip will eventually be removed when the anchor bolt 45 is put into use as part of the building construction.

The housing 50 is uncoupled from the clip 21 by rotating it in the opposite direction to unlock the knobs 29 from the slots 55. This may be done before or after the clip 21 is removed from the anchor bolt 45. The housing 50 may then be lifted and removed. The clip 21 may be removed by unscrewing, ratcheting or sliding it up to the top of the anchor bolt 45 before or after the housing 50 is uncoupled.

The housing 50 and/or clip 21 may be re-used multiple times and provide for reliable and secure positioning and identification of anchor bolts 45 before, during and after concrete is poured.

It is to be appreciated that aside from the illustrated embodiments, different versions of the invention may be made from different combinations of the various features described above. It is also to be appreciated that the different steps of the methods of using the invention may be performed in different orders or sequences to accomplish the same result.

It is to be understood that other variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. An anchoring member positioning apparatus comprising:
a. a hollow open-ended sleeve member having a central axis, a plurality of flanges extending inward toward said axis for engagement with an anchoring member, and at least one knob extending outward from said sleeve;
b. a housing having a peripheral exterior wall, a hollow interior, a central axis and at least one open end, the wall adjacent to said open end having at least one slot for engagement with said at least one knob of said sleeve member;
c. at least one leg member attached to said housing extending outwardly therefrom; and
d. at least one extension movably attached at one end to one of said housing, said at least one leg member, and combinations thereof, said extension having at least one opening thereon for use in engaging said extension with a structural member.

2. The apparatus of claim 1 wherein a foot member is provided with each leg member.

3. The apparatus of claim 1 wherein at least one tier is provided on said extension.

4. The apparatus of claim 1 wherein an inwardly extending tooth is provided on at least one of said flanges.

5. The apparatus of claim 1 wherein at least one of said flanges is of a different length than another of said flanges.

6. The apparatus of claim 1 wherein said housing slot has an L-shape, and a ridge is provided in said slot.

7. The apparatus of claim 1 wherein a notch is provided on said housing for receiving an opposite end of said extension.

8. The apparatus of claim 1 wherein said sleeve member has a generally cylindrical shape.

9. The apparatus of claim 1 wherein said housing member has a generally cylindrical shape.

10. The apparatus of claim 1 wherein said extension further comprises an outwardly extending tab.

11. The apparatus of claim 1 wherein said clip and housing are of different colors.

12. An anchoring member positioning apparatus comprising:
a. a clip means including a plurality of flange means for temporarily but securely engaging the shaft of an anchoring member;
b. a housing means for temporarily but securely engaging said clip means;
c. at least one extension means movably attached to said housing means for temporary but secure engagement with an exterior support means.

13. A method for securing the position of an anchoring member during the installation of concrete around said member comprising the steps of:
a. temporarily coupling a housing to a clip, said clip comprising a hollow open-ended sleeve member having a central axis, a plurality of flanges extending inward toward said axis for engaging said anchoring member, and at least one outwardly extending knob for engagement with at least one corresponding slot on said housing; said housing comprising a peripheral exterior wall, a hollow interior, and an opening at one end for receiving said clip, said slot being located in the wall adjacent to said open end;
b. moving the coupled housing-clip to a location where said anchoring member is to be deployed;
c. moving out an extension that is movably attached at one end to said housing so that said extension makes contact with a fixed-position structural member;
d. temporarily attaching said extension to said structural member; and
e. inserting said anchoring member into said coupled housing-clip along said central axis.

14. The method of claim 13 further comprising the step of pouring concrete around said anchoring member.

15. The method of claim 14 further comprising the step of detaching said extension from said structural member.

16. The method of claim 15 further comprising the step of moving an opposite end of said extension up against said housing.

17. The method of claim 13 wherein said anchoring member is inserted a measured distance into said clip.

18. The method of claim 18 further comprising the step of using measuring indicia on said housing to roughly determine the distance said anchoring member is to be inserted into said clip.

19. The method of claim 16 further comprising the step of detaching said coupled housing-clip from said anchoring member.

20. A method for securing the positions of a plurality of anchoring members during the installation of concrete around said members comprising the steps of:
a. selecting clips that are sized to fit each of the anchoring members to be installed;
b. temporarily coupling a housing to each clip, each such clip comprising a hollow open-ended sleeve member having a central axis, a plurality of flanges extending inward toward said axis for engaging an anchoring members, and at least one outwardly extending knob for engagement with at least one corresponding slot on a housing; each such housing comprising a peripheral exterior wall, a hollow interior, and an opening at one end for receiving a clip, such slot being located in the housing wall adjacent to said open end;
b. moving each coupled housing-clip to a location where an anchoring members is to be deployed;
c. moving out an extension that is movably attached to each housing so that said extension makes contact with a fixed-position structural member;
d. temporarily attaching each extension to such structural member; and
e. inserting an anchoring members into each of said coupled housing-clips along each central axis.

21. An anchoring member positioning apparatus comprising:
a. a hollow open-ended sleeve member having a central axis, a plurality of flanges extending inward toward said axis for engagement with an anchoring member, and at least one knob extending outward from said sleeve;
b. a housing having a peripheral exterior wall, a hollow interior, a central axis and at least one open end, the wall adjacent to said open end having at least one slot for engagement with said at least one knob of said sleeve member;
c. at least one leg member attached to said housing extending outwardly therefrom;
d. at least one foot member attached to at least one leg member; and
d. at least one extension movably attached to one of said housing, said at least one leg member, said at least one foot member, and combinations thereof, said extension having at least one opening thereon for use in engaging said extension with a structural member.
